(19) United States
(12) Patent Application Publication
(10) Pub. No.: US 2014/0044907 A1
(43) Pub. Date: Feb. 13, 2014

(54) FRAMED WINDOW PANE AND METHOD FOR MANUFACTURING FRAMED WINDOW PANE

(71) Applicant: ASAHI GLASS COMPANY, LIMITED, Chiyoda-ku (JP)

(72) Inventor: Takanobu KONDO, Tokyo (JP)

(73) Assignee: ASAHI GLASS COMPANY, LIMITED, Chiyoda-ku (JP)

(21) Appl. No.: 14/052,164

(22) Filed: Oct. 11, 2013

Related U.S. Application Data
(63) Continuation of application No. PCT/JP12/60063, filed on Apr. 12, 2012.

(30) Foreign Application Priority Data
Apr. 12, 2011 (JP) 2011-088341

(51) Int. Cl. B60J 1/00; B32B 3/08; B29C 45/14

(52) U.S. Cl. CPC B60J 1/008; B29C 45/14434; B32B 3/08
USPC 428/38; 264/271.1

(57) ABSTRACT

The present invention relates to a sheet material for a window with a frame member in which a resin frame member is molded integrally on at least one of an indoor side surface and a peripheral surface of the sheet material for a window at a circumferential edge portion thereof, in which the sheet material for a window includes a chamfered surface on the circumferential edge portion, and in a plan view of the sheet material for a window, a chamfered width w of the chamfered surface and a curvature radius r of a corner portion of a non-chamfered area satisfy w≧r and r<3 mm.

### TECHNICAL FIELD

The present invention relates to a sheet material for a window with a frame member for use as a window glass for a vehicle and a method for producing the sheet material for a window with a frame member.

### BACKGROUND ART

In the case where a glass sheet for a window (a sheet material for a window) is attached to an opening portion for a window of a vehicle, a long or frame-shaped resin molding (hereinafter, referred to as a frame member) is attached to a gap between a circumferential edge portion of the glass sheet and the opening portion for a window. Sealing the gap by the frame member enables to prevent rainwater or the like from entering an inside of a vehicle. As the configuration of such a sheet material for a window with a frame member, there are known a configuration called a “three-surface molding” described in Patent Document 1 and a configuration called a “two-surface molding” described in Patent Document 2.

The three-surface molding has a shape that a cross-section surface of a frame member is an approximately U-shaped so that the frame member contacts the glass sheet at three surfaces in total of an outer side surface, an inner side surface and a peripheral surface of the glass sheet.

By contrast, the two-surface molding has a shape that a cross-section surface of a frame member is an approximately L-shaped so that the frame member contacts the glass sheet at two surfaces in total of an inner side surface and a peripheral surface of the glass sheet, and that the frame member does not project from an outer side surface of the glass sheet.

Compared with the three-surface molding, in the two-surface molding, the frame member does not project outside of a vehicle, and a flush-surfaced vehicle body can be achieved. Consequently, the two-surface molding can provide not only a superior external appearance but also an advantage that air is allowed to flow smoothly from a windshield to a rear window while running a vehicle, and that the generation of uncomfortable wind noise is reduced.

Incidentally, in a conventional sheet material for a window with a frame member 1 having the two-surface molding shown in FIGS. 6 and 7, in general, a corner portion 3 of a glass sheet 2 is proceeded so that a curvature radius r of the corner portion 3 falls within a range of 3 mm<r<8 mm. Therefore, at a corner portion 4 of the sheet material for a window with a frame member 1, a parting line (a boundary line) L between the glass sheet 2 and the frame member 5 is formed into a large arc-like shape, leading to a problem that the external design gets deteriorated. Namely, in order to enhance the external design, the parting line L needs to be formed into a pin-angle shape (which will be described later).

In addition, due to the fact that the curvature radius of the corner portion 3 of the glass sheet 2 is large as described above, the corner portion 3 cannot be extended to the vicinity of a distal end portion 6a of a corner portion 6 (which is the same as the corner portion 4 of the sheet material for a window with a frame member 1) of the frame member 5 as shown in FIG. 7. Therefore, the rigidity of the corner portion 4 of the sheet material for a window with a frame member 1 cannot be enhanced. In addition, when a gap between the corner portion 3 of the glass sheet 2 and the corner portion 6 of the frame member 5 is filled with the frame member 5 made of resin, the volume of the resin used to fill the gap becomes large, and this may lead to a problem that undesirable depressions (hereinafter, referred to as sink marks) are produced in a surface of the frame member 5 due to the shrinkage while curing. Consequently, a lightening portion 7 needs to be formed in an inner side surface of the frame member 5 so as to prevent the production of visible sink marks in the surface of the corner portion 6 of the frame member 5. This also causes reduction in the rigidity of the corner portion 4 of the sheet material for a window with a frame member 1.

It is general practice that a portion of the opening portion for a window where the corner portion 4 of the sheet material for a window with the frame member 1 is received is formed into a sharp shape in order to enhance the external design of a vehicle body. Therefore, in the conventional sheet material for a window with a frame member 1, a long distance has to be taken between the corner portion 3 of the glass sheet 2 and the distal end portion 6a of the corner portion 6 of the frame member 5, this causes the problem described above.

Incidentally, the applicant of the present application provides a sheet material for a window with a resin frame member in which the resin frame member is injection-molded integrally around a circumference of a glass sheet (marketed under the registered trademark of “MAW”, MODULUS ASSY WINDOW) as a window glass for a vehicle (Patent Document 3).

### BACKGROUND ART DOCUMENT

### Patent Document

Patent Document 1: JP-A-2002-129839

Patent Document 2: JP-A-11-129747

Patent Document 3: JP-A-2002-292681

### SUMMARY OF THE INVENTION

### Problems that the Invention is to Solve

The invention has been made in view of these situations, and an object thereof is to provide a sheet material for a window with a frame member which can provide an improved external design and higher rigidity.

### Means for Solving the Problems

In order to achieve the above-mentioned object, the invention provides a sheet material for a window with a frame member in which a resin frame member is molded integrally on at least one of an indoor side surface and a peripheral surface of the sheet material for a window at a circumferential edge portion thereof, wherein the sheet material for a window comprises a chamfered surface on the circumferential edge portion, and, in a plan view of the sheet material for a window, a chamfered width w of the chamfered surface and a curvature radius r of a corner portion of a non-chamfered area satisfy w≧r and r<3 mm.

In order to achieve the above-mentioned object, the invention also provides a method for producing a sheet material for a window with a frame member, the method comprising: closing and clamping a mold having a lower mold and an upper mold which are disposed to face each other so as to form a cavity therebetween; and molding a resin frame member integrally along a circumferential edge portion of a sheet material for a window, wherein, in a plan view of the sheet material for a window, the sheet material for a window is chamfered so that a chamfered width w of a chamfered surface and a curvature radius r of a corner portion of a non-chamfered area satisfy w≧r, and r<3 mm, and the sheet material for a window is clamped by the mold so as to mold the resin frame member integrally along the circumferential edge portion of the sheet material for a window.

In the sheet material for a window with a frame member according to one embodiment of the invention, it is preferred that the chamfered width w and a thickness t of the sheet material for a window satisfy w≦5 t/2, and the thickness t satisfies 2 mm≦t ≦6 mm.

In the sheet material for a window with a frame member according to one embodiment of the invention, in the plan view of the sheet material for a window, a distance M1 between the corner portion of the non-chamfered area and a corner portion of the frame member is preferably 0.8 mm≦M1≦6 mm, and more preferably 3 mm≦M1≦6 mm.

In the sheet material for a window with a frame member according to one embodiment of the invention, an angle a of the corner portion of the non-chamfered area is preferably 20°≦α≦90°, and more preferably 25°≦α≦60°.

In the sheet material for a window with a frame member according to one embodiment of the invention, the sheet material for a window is preferably used for a window glass for a vehicle.

In the sheet material for a window with a frame member according to one embodiment of the invention, it is more preferred that the sheet material for a window is a strengthened glass and is used for a fixed window of a vehicle.

### Advantage of the Invention

According to the sheet material for a window with a frame member according to one embodiment of the invention, the improved external design and higher rigidity can be obtained.

### BRIEF DESCRIPTION OF THE DRAWINGS

FIG. 1 is an enlarged view of a main part of a sheet material for a window with a frame member representing an embodiment.

FIG. 2 is a sectional view of the sheet material for a window with a frame member shown in FIG. 1 along the line A-A in the figure.

FIG. 3 is an explanatory view used to explain a pin-angle shape of a glass sheet.

FIG. 4 is a sectional view of the sheet material for a window with a frame member shown in FIG. 1 along the line B-B in the figure.

FIG. 5 is a sectional view showing a peripheral surface shape of the glass sheet which has a chamfered surface with a plurality of curvature radii.

FIG. 6 is an enlarged plan view of a main part of a conventional sheet material for a window with a frame member.

FIG. 7 is a sectional view of the sheet material for a window with a frame member shown in FIG. 6 along the line A-A in the figure.

FIG. 8 is a view showing one embodiment of a method for producing the sheet material for a window with a frame member according to the invention.

### MODE FOR CARRYING OUT THE INVENTION

Hereinafter, a preferred embodiment of a sheet material for a window with a frame member according to the invention will be described in detail based on the accompanying drawings.

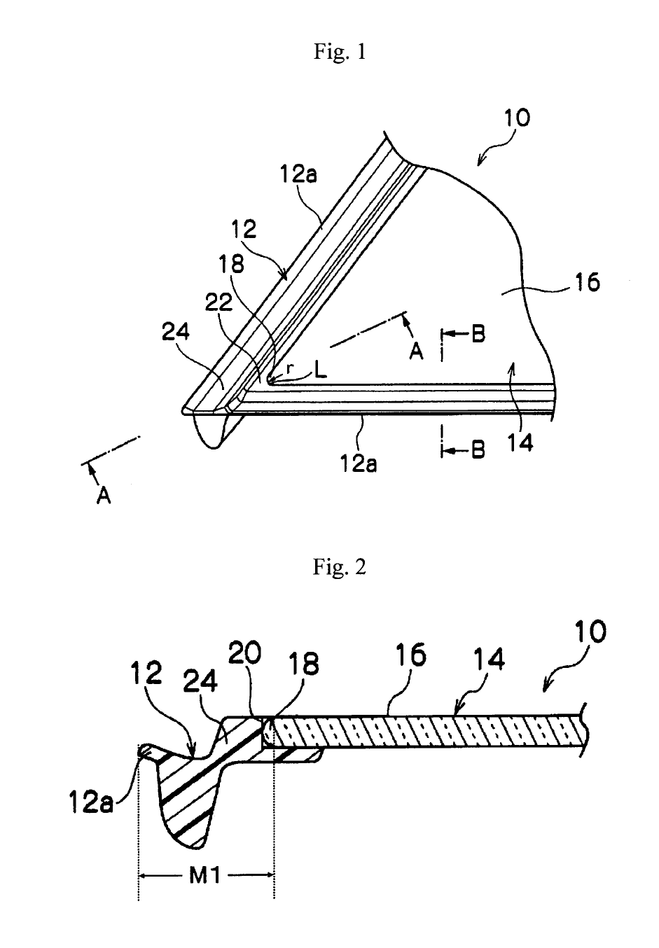

FIG. 1 is an enlarged view of a main part of a sheet material for a window with a frame member (hereinafter, referred to as a glass sheet with a frame member) 10 representing an embodiment of the invention, and FIG. 2 is a sectional view along the line A-A in FIG. 1.

A glass sheet with a frame member 10 shown in these drawings is a front bench glass having a triangular surface which is attached to an opening portion for a window of a vehicle. However, the sheet material for a window with a frame member of this embodiment is not limited to the application for the front bench glass and hence can also be applied preferably to a fixed window such as side glass, rear quarter glass, windshield, rear window or roof glass.

In addition, in this embodiment, while a resin frame member will be described as a frame member 12 of the glass sheet with a frame member 10, this resin frame member is a member used to close a gap between the opening portion for a window in a vehicle and a glass sheet 14 for a window. Consequently, in addition to a resin molding, the frame member may be formed to contain various insert members such as, a resin garnish, a metallic member which are attached integrally to the molding by injection-molding or the like and a lip molding which is subject to contact with an opening portion in the vehicle. Additionally, the frame member includes in its concept a resin frame member to which a member designed to enhance the design and functional properties is assembled further after the resin molding is molded (a so-called retrofit assembling).

Further, in the glass sheet 14 attached to the opening portion for a window, an outer side of a vehicle is referred to as a front surface, and an inner side of a vehicle as a rear surface. Thus, FIG. 1 is a perspective view of the glass sheet with a frame member 10 with the front surface of the glass sheet 14 made visible.

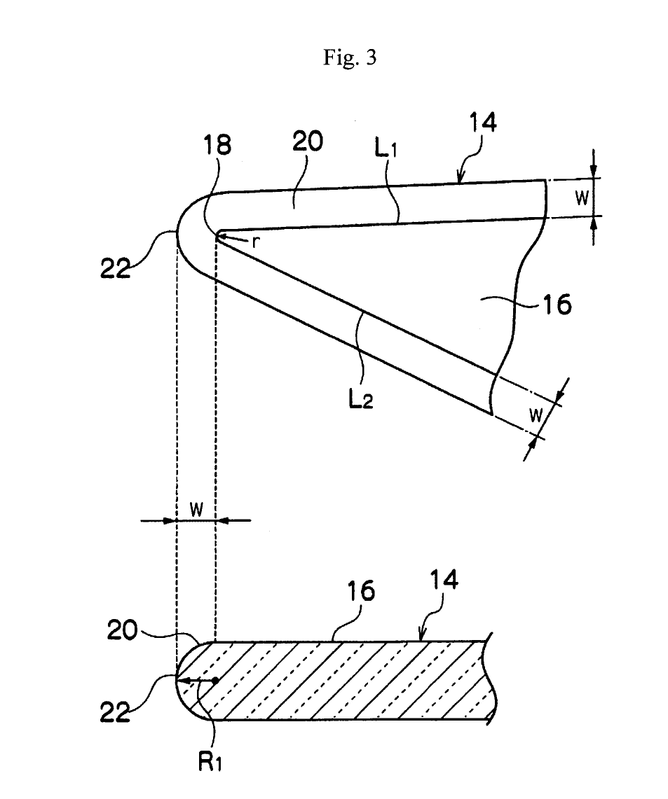

Furthermore, the pin-angle shape described in the description of the background art means a sharp shape in which an outer edge portion of a non-chamfered area 16 on the front surface of the glass sheet 14 shown in FIG. 3 is formed in a corner portion 18 of the non-chamfered area by intersection of not curves but two straight lines L₁ and L₂ which are boundary lines between a chamfered surface 20 and the non-chamfered area 16.

This enables the external design to improve since in a corner portion 22 of the glass sheet of the glass sheet with a “two-surface molding” frame member 10 shown in FIGS. 1 and 2, a parting line L between the frame member 12 and the glass sheet 14 is seen as the pin-angle shape. That is, the sheet material for a window with a frame member according to this embodiment is intended for a glass sheet with a frame member 10 of not “three-surface molding” but “two-surface molding” or of a “single-surface molding” in which the frame member 12 is attached to at least one of the rear surface or a peripheral surface of the glass sheet 14. Namely, in the glass sheet with the “three-surface molding” frame member, the frame member is attached to the front surface and the rear surface of the glass sheet, and therefore, the parting line L shown in FIG. 1 cannot be exposed. The sheet material for a window with a frame member of the “two-surface molding” and the sheet material for a window with a frame member of the “single-surface molding” are sheet materials for a window which satisfy the market's demand of exposing the glass sheet to as large an extent as possible while the frame member is exposed to as small an extent as possible.

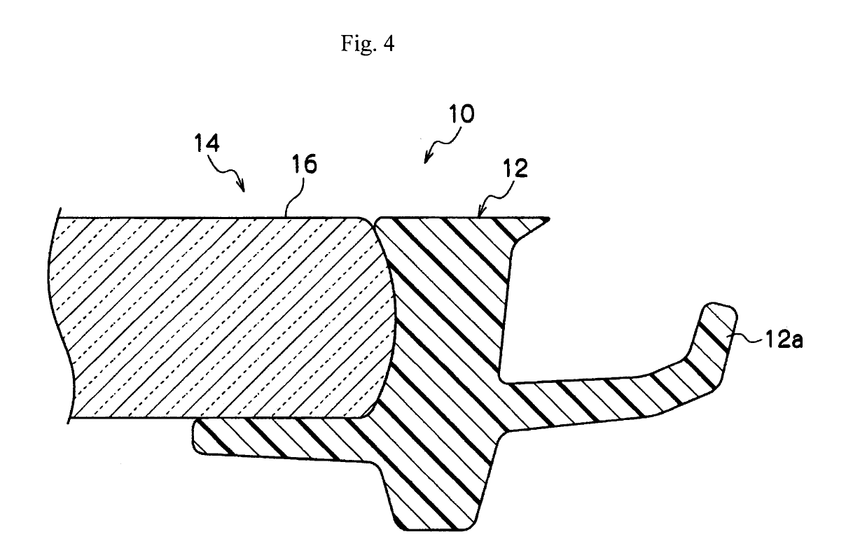

The glass sheet with a frame member 10 of this embodiment includes the glass sheet 14 and the frame member 12, and is fixed to the opening portion for a window in the vehicle via an adhesive. In addition, a gap between the end portion of the glass sheet 14 and the opening portion for a window is sealed by a lip portion 12a provided along an outer circumferential edge portion of the frame member 12 shown in FIGS. 1, 2 and 4. Incidentally, FIG. 4 is a sectional view of the sheet material for a window with a frame member 10 shown in FIG. 1 along the line B-B in the figure.

An elastic resin material such as TPO (olefin-based thermoplastic elastomer), TPE (ethylene-based thermoplastic elastomer) or PVC (polyvinyl chloride) can be raised as the material of the frame member 12. In addition, a urethane adhesive can be preferably used as the adhesive with which the frame member 12 is fixed to the opening portion for a window.

Although a single glass sheet may be used as the glass sheet 14, a laminated glass sheet with an intermediate film of PVB or the like interposed between constituent glass sheets may be used. In addition, the sheet material for a window is not limited to the glass sheet 14, and hence, a panel of organic resin such as transparent resin or semi-transparent resin or a composite material of a glass sheet and the organic resin may be used.

Next, the characteristics of the glass sheet with a frame member 10 of the embodiment will be described.

As shown in FIG. 3, this glass sheet with a frame member 10 includes the corner portion 22 of the glass sheet 14 and the chamfered surface 20 formed along the circumferential edge portion of the glass sheet 14. In a plan view of the glass sheet 14, a chamfered width w of the chamfered surface 20 and a curvature radius r of the corner portion 18 of the non-chamfered area 16 satisfy w≧r, and r<3 mm.

By producing the glass sheet 14 which satisfies w≧r, and r<3 mm, as shown in FIG. 1, the parting line L between the glass sheet 14 and the frame member 12 in the corner portion 22 of the glass material with a frame member 10 can be formed into the pin-angle shape. In FIG. 3, assuming that an angle at which the straight lines L₁ and L₂ intersect each other to form the sharp shape is an angle a, the pin-angle shape is formed so that the angle a preferably satisfies 20°≦α≦90° and more preferably satisfies 25°≦α≦60° in view of consistency with a design of a vehicle.

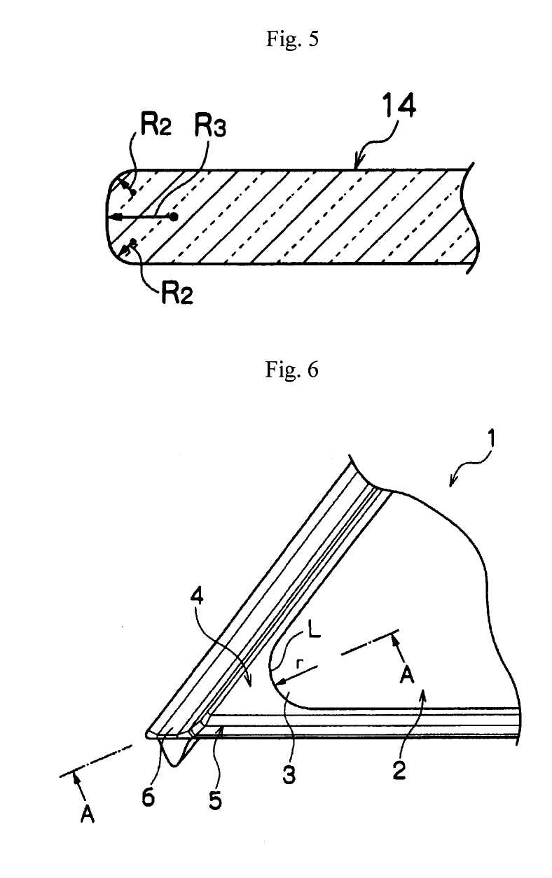

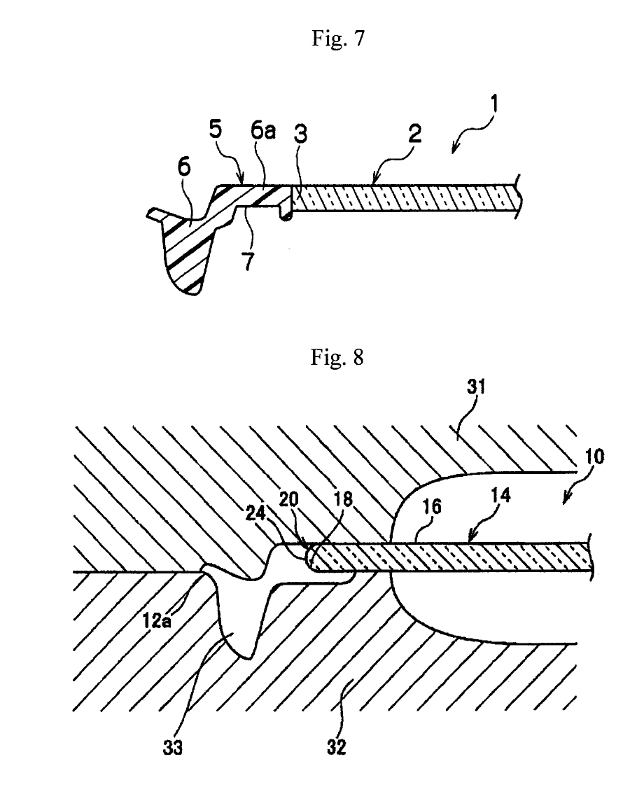

By adopting this configuration, according to the glass sheet with a frame member 10, the external design is improved, compared to the conventional glass sheet with a frame member 1 shown in FIG. 6. In addition, as shown in FIG. 2, the corner portion 18 of the non-chamfered area 16 can be existed to the vicinity of the lip portion (a distal end portion) 12a of the frame member 12. Thus, the rigidity of the frame member 12 at the corner portion 22 of the glass sheet with a frame member 10 is enhanced, this enhances the overall rigidity of the glass sheet with a frame portion 10. Further, since a lightening portion does not have to be provided on an inner side of a vehicle of a corner portion 24 in the frame member 12, the rigidity is enhanced further, the volume of the resin used to fill the gap is reduced, and the glass material with a frame member 10 which provides a good external design by suppressing the formation of sink marks due to the shrinkage while curing, can be obtained. This advantage becomes remarkable with the sheet material for a window with frame member of the two-surface molding.

In addition, if a distance M1 between the corner portion 18 of the non-chamfered area and the corner portion 12a of the frame member shown in FIG. 2 is made short, the rigidity of the corner portion of the glass sheet with a frame member 10 is improved. With M1 being shorter than 6 mm, the rigidity of the corner portion is enhanced higher than that of the conventional glass sheet with a frame member, with M1 being 0.8 mm or larger, the frame member 12 can be molded integrally to the glass sheet with a frame member 10, and with M1 being 3 mm or larger, the degree of freedom in relation to sectional shape is improved, which is preferable to impart a shape including such a functionality as a lip.

Additionally, in order to obtain the glass sheet 14 shown in FIG. 3, that is, in order to obtain the glass sheet 14 in which the corner portion 18 of the non-chamfered area is formed into the pin-angle shape, in a chamfering step of an edge portion of the glass sheet 14, the edge portion is chamfered by using a grinding stone with which a minute chamfering can be implemented. In this case, a chamfering R is smaller than R3, preferably R1.5, and more preferably R1 or less.

Namely, the chamfering R and the chamfered width w take substantially equal values. In addition, the chamfering R may be obtained with a single curvature radius of R₁ as shown in FIG. 3 or obtained with a combination of curvature radii of R₂ and R₃ as shown in FIG. 5. Further, a thread chamfering may be adopted as chamfering. Also, in plan view, a thread chamfered width C and the chamfered width w take substantially equal values as well.

On the other hand, it is preferred that the chamfered width w and the thickness t of the glass sheet 14 satisfy w≦t/2 and that the thickness t is 2 mm≦t≦6 mm. In the case where the thickness t falls within the range, the glass sheet with a frame member 10 can preferably be used as a strengthened glass for a vehicle.

As described above, the chamfering R and the chamfered width w take substantially equal values. In addition, when chamfered with the single curvature radius R₁, a maximum value of the chamfering R is t/2, and therefore, the chamfered width w becomes w≦t/2. The thickness t of the glass sheet 14 is preferably in the range of 2.3 to 5 mm and is more preferably in the range of 2.5 to 3.5 mm, and w, r and R may be set according to the thickness t.

If the thickness t of the sheet material for a window is large, strengthening of a glass is facilitated, and the resistance to breakage by jumping stone is improved. In the case where the thickness is 3.5 mm or smaller or preferably 2.5 mm or smaller, the resulting thickness contributes to a reduction in weight of the sheet material for a window with a frame member. In the case where the thickness t is 2.5 mm or larger, the resulting thickness makes it easy to ensure a performance required on vehicle safety glass, however, in the case where the thickness is 2 mm or smaller, it becomes difficult to strengthen a glass by using a known method, and the application range of a window glass for a vehicle is limited.

One embodiment of a method for producing the sheet material for a window with a frame member of the invention will be described based on FIG. 8. As shown in FIG. 8, by using a mold having a cavity 33 formed between an upper mold 31 and a lower mold 32, the glass sheet 14 was placed in a predetermined position on the lower mold 32 with the mold opened, and then, the upper mold 31 was closed to clamp the mold. Thereafter, a resin including soft PVC was poured into an interior of the cavity in the mold from a sprue (not shown) so that a resin frame member 12 was injection-molded integrally on the glass sheet 14. After being cooled, the mold was opened, and then, the sheet material for a window with the resin frame member 12 was obtained.

While the invention has been described in detail with reference to specific embodiments thereof, it will be apparent to one skilled in the art that various changes and modifications can be made therein without departing from the spirit and scope thereof. Incidentally, the present application is based on Japanese Patent Application No. 2011-088341 filed on Apr. 12, 2011, and the contents are incorporated herein by reference.

### DESCRIPTION OF REFERENCE NUMERALS AND SIGNS

10 Glass sheet with a frame member;

12 Frame member;

14 Glass sheet;

16 Non-chamfered area;

18 Corner portion of non-chamfered area;

20 Chamfered surface;

22 Corner portion of glass sheet;

24 Corner portion of frame member;

31 Upper mold;

32 Lower mold;

33 Cavity.

1. A sheet material for a window with a frame member in which a resin frame member is molded integrally on at least one of an indoor side surface and a peripheral surface of the sheet material for a window at a circumferential edge portion thereof,
wherein the sheet material for a window comprises a chamfered surface on the circumferential edge portion, and
in a plan view of the sheet material for a window, a chamfered width w of the chamfered surface and a curvature radius r of a corner portion of a non-chamfered area satisfy w≧r and r<3 mm.

2. The sheet material for a window with a frame member according to claim 1, wherein the chamfered width w and a thickness t of the sheet material for a window satisfy w≦t/2, and the thickness t satisfies 2 mm≦t≦6 mm.

3. The sheet material for a window with a frame member according to claim 1, wherein, in the plan view of the sheet material for a window, a distance M1 between the corner portion of the non-chamfered area and a corner portion of the frame member is 0.8 mm≦M1≦6 mm.

4. The sheet material for a window with a frame member according to claim 1, wherein, in the plan view of the sheet material for a window, an angle a of the corner portion of the non-chamfered area is 20°≦α≦90°.

5. The sheet material for a window with a frame member according to claim 1, wherein the sheet material for a window is a window glass for a vehicle.

6. The sheet material for a window with a frame member according to claim 1, wherein the sheet material for a window is a strengthened glass and is used for a fixed window of a vehicle.

7. A method for producing a sheet material for a window with a frame member, the method comprising:
closing and clamping a mold having a lower mold and an upper mold which are disposed to face each other so as to form a cavity therebetween; and
molding a resin frame member integrally along a circumferential edge portion of a sheet material for a window,
wherein, in a plan view of the sheet material for a window, the sheet material for a window is chamfered so that a chamfered width w of a chamfered surface and a curvature radius r of a corner portion of a non-chamfered area satisfy w≧r, and r<3 mm, and the sheet material for a window is clamped by the mold so as to mold the resin frame member integrally along the circumferential edge portion of the sheet material for a window.

8. The method for producing a sheet material for a window with a frame member according to claim 7, wherein the sheet material for a window is set so that a distance M1 between the corner portion of the non-chamfered area and a corner portion of the frame member in the cavity is 0.8 mm≦M1≦6 mm.
